(19) United States
(12) Patent Application Publication
(10) Pub. No.: US 2021/0158337 A1
(43) Pub. Date: May 27, 2021

(54) PAYMENT PROCESSING METHOD AND PAYMENT PROCESSING DEVICE

(71) Applicant: KDDI CORPORATION, Tokyo (JP)

(72) Inventor: Tooru SHIMIZU, Tokyo (JP)

(73) Assignee: KDDI CORPORATION, Tokyo (JP)

(21) Appl. No.: 17/098,819

(22) Filed: Nov. 16, 2020

(30) Foreign Application Priority Data
Nov. 27, 2019 (JP) 2019-214152
Nov. 27, 2019 (JP) 2019-214153

(51) Int. Cl. G06Q 20/36; G06Q 20/22; G06Q 20/26; G06Q 20/40; G06Q 20/32

(52) U.S. Cl. CPC G06Q 20/3672; G06Q 20/227; G06Q 20/3274; G06Q 20/407; G06Q 20/405; G06Q 20/26

(57) ABSTRACT

A payment processing device includes a payment request acquisition unit configured to acquire a payment request corresponding to a first payment scheme with respect to an amount of money to be paid by a user, a determination unit configured to determine whether or not a second payment scheme associated with the user satisfies a predetermined condition when the balance of an account of the user associated with the first payment scheme is less than the amount of money to be paid; and a payment unit configured to allow the balance of the account of the user in the first payment scheme to be insufficient and perform payment of the amount of money to be paid according to the first payment scheme if the determination unit determines that the second payment scheme satisfies the predetermined condition.

### BACKGROUND OF THE INVENTION

### Field of the Invention

The present invention relates to a payment processing method and a payment processing device.

Priority is claimed on Japanese Patent Application Nos. 2019-214152 and 2019-214153, filed Nov. 27, 2019, the content of which is incorporated herein by reference.

### Description of Related Art

Code payment using a two-dimensional barcode such as a QR code (registered trademark) has become widespread, as disclosed in Japanese Patent No. 6528160 and Japanese Patent No. 6473539. Code payment is performed when a user terminal reads a two-dimensional barcode displayed by a device on a shop side or when a device on the shop side reads a two-dimensional barcode displayed by a user terminal.

### SUMMARY OF THE INVENTION

In a conventional code payment, when the balance of an account corresponding to the code payment is less than an amount of money to be paid, an error message is displayed and the payment is interrupted. On the other hand, the user needs to pay in cash or deposit money into the account through a charge process to perform the code payment again and there is a problem that time and effort are required.

Also, in the conventional code payment, if it is determined that the balance of the account corresponding to the code payment is less than the amount of money to be paid after the two-dimensional barcode is read, an error message or the like is displayed and the payment is interrupted, so that there is a problem that a process until the payment is interrupted is time-consuming.

The present invention has been made in view of these points and an objective of the present invention is to provide a payment processing method and a payment processing device capable of reducing a burden on a user when an account balance is insufficient at the time of payment.

Furthermore, an objective of the present invention is to provide a payment processing method and a payment processing device capable of promptly interrupting payment when it is determined that an account balance is likely to be insufficient before the payment starts.

According to a first aspect of the present invention, there is provided a payment processing method including steps of: acquiring, by a computer, a payment request corresponding to a first payment scheme with respect to an amount of money to be paid by a user; determining, by the computer, whether or not a second payment scheme associated with the user satisfies a predetermined condition when the balance of an account of the user associated with the first payment scheme is less than the amount of money to be paid; and allowing, by the computer, the balance of the account of the user in the first payment scheme to be insufficient if it is determined that the second payment scheme satisfies the predetermined condition and performing payment of the amount of money to be paid according to the first payment scheme.

According to a second aspect of the present invention, there is provided a payment processing device including: an acquisition unit configured to acquire a payment request corresponding to a first payment scheme with respect to an amount of money to be paid by a user; a determination unit configured to determine whether or not a second payment scheme associated with the user satisfies a predetermined condition when the balance of an account of the user associated with the first payment scheme is less than the amount of money to be paid; and a payment unit configured to allow the balance of the account of the user in the first payment scheme to be insufficient if the determination unit determines that the second payment scheme satisfies the predetermined condition and perform payment of the amount of money to be paid according to the first payment scheme.

According to a third aspect of the present invention, there is provided a payment processing method including steps of: acquiring, by a computer, user identification information for identifying a user who has transmitted a code issuance request in association with a payment scheme using a code from a terminal of the user; determining, by the computer, whether or not an account associated with the payment scheme of the user corresponding to the acquired user identification information satisfies a predetermined condition representing a state in which payment is possible; and generating, by the computer, a token related to the code corresponding to the user displayed on the terminal of the user when it is determined that the account satisfies the predetermined condition.

According to a fourth aspect of the present invention, there is provided a payment processing device including: an acquisition unit configured to acquire user identification information for identifying a user who has transmitted a code issuance request in association with a payment scheme using a code from a terminal of the user; a determination unit configured to determine whether or not an account associated with the payment scheme of the user corresponding to the user identification information acquired by the acquisition unit satisfies a predetermined condition representing a state in which payment is possible; and a token generation unit configured to generate a token related to the code corresponding to the user displayed on the terminal of the user when the determination unit determines that the account satisfies the predetermined condition.

According to the present invention, as an advantageous effect, it is possible to reduce a burden on a user when an account balance is insufficient at the time of payment.

Also, according to the present invention, as an advantageous effect, it is possible to promptly interrupt payment when it is determined that an account balance is likely to be insufficient at the time of payment.

### BRIEF DESCRIPTION OF THE DRAWINGS

FIG. 1 is a block diagram showing a process of a payment processing device according to a first embodiment of the present invention.

FIG. 2 is a block diagram showing a functional configuration of the payment processing device in the first embodiment.

FIG. 3 is a block diagram showing a functional configuration of a user terminal in the first embodiment.

FIG. 4 is a block diagram showing a functional configuration of a shop terminal in the first embodiment.

FIG. 5A is a table showing a process of the payment processing device when the balance of an account of a user in code payment is insufficient in the first and second embodiments.

FIG. 5B is a table showing another process of the payment processing device when the balance of an account of the user in code payment is insufficient in the first and second embodiments.

FIG. 6 is a flowchart showing a process of the payment processing device in the first embodiment.

FIG. 7 is a flowchart showing a process of the payment processing device when the balance of the account associated with the code payment is insufficient in the first and second embodiments.

FIG. 8 is a block diagram showing a process of the payment processing device in a modified example of the first embodiment.

FIG. 9 is a block diagram showing a process of a payment processing device according to a second embodiment of the present invention.

FIG. 10 is a block diagram showing a functional configuration of the payment processing device in the second embodiment.

FIG. 11 is a block diagram showing a functional configuration of a user terminal in the second embodiment.

FIG. 12 is a block diagram showing a functional configuration of a shop terminal in the second embodiment.

FIG. 13 is a flowchart showing a process of the payment processing device in the second embodiment.

FIG. 14 is a block diagram showing a process of the payment processing device in a modified example of the second embodiment.

### DETAILED DESCRIPTION OF THE INVENTION

### First Embodiment

### [Outline of Payment Processing Device 11]

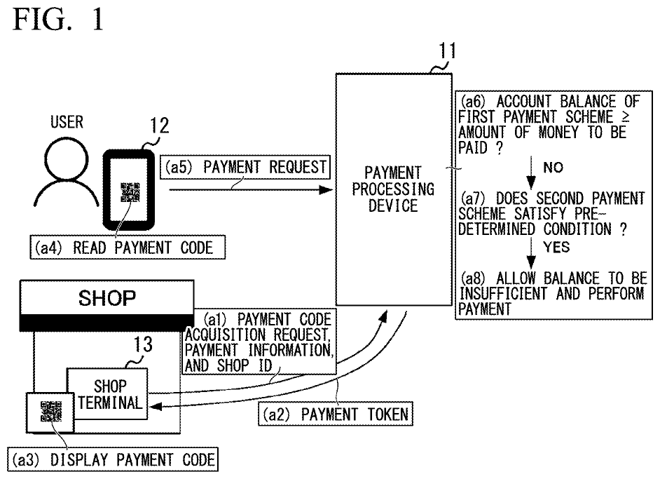

FIG. 1 is a diagram showing an outline of a payment processing device 11. The payment processing device 11 is a computer for performing payment in accordance with reception of a payment code from a user terminal 12 or a shop terminal 13 when a user purchases a product. The payment code is text or an image that can be read by the user terminal 12 or the shop terminal 13 and is a code used at the time of the payment.

The payment processing device 11 is connected to the user terminal 12 and the shop terminal 13 via communication networks such as a portable phone network and the Internet. The user terminal 12 is a portable terminal used by the user, and is, for example, a smartphone, a tablet, a wearable device, or a personal computer. The shop terminal 13 is, for example, a POS terminal.

Hereinafter, a flow until payment for the price of a product is performed will be described with reference to an example in which payment is performed according to code payment. FIG. 1 shows an example in which payment is performed in accordance with the fact that the payment processing device 11 has identified that the user terminal 12 has read the payment code. Also, in the present embodiment, a payment scheme for paying an amount of money is associated with the code payment serving as a first payment scheme in the payment processing device 11. In the present embodiment, it is assumed that a prepaid account payment scheme in which a balance in a prepaid account is managed and an amount of money to be paid is paid from the balance is associated with a payment scheme associated with the first payment scheme. The prepaid account may be associated with a prepaid card owned by the user.

First, the user purchases a product in the shop. A clerk in the shop reads a barcode attached to a product purchased by the user in the shop terminal 13 when the user performs an accounting process in the shop and causes the shop terminal 13 to generate payment information representing a total amount of money for products purchased by the user, i.e., an amount of money to be paid by the user. The payment information may include information about a payment target product. Also, the clerk performs an operation for causing the shop terminal 13 to display the payment code in the shop terminal 13. The shop terminal 13 transmits a payment code acquisition request, payment information, and a shop ID for identifying the shop to the payment processing device 11 ((a1) in FIG. 1). Here, the shop ID may be information for identifying an individual terminal installed within the shop.

When the payment code acquisition request, the payment information, and the shop ID are received from the shop terminal 13, the payment processing device 11 generates a payment token. The payment processing device 11 may determine whether or not the shop identified by the received shop ID has been registered as a shop where code payment is available (a code payment member shop) by the payment processing device 11 and generate the payment token when it is determined that the shop identified by the received shop ID has been registered as a code payment member shop. The payment token is a one-time data string used when the shop terminal 13 generates a payment code to be presented to the user by the shop terminal 13 with respect to a code acquisition request. The payment processing device 11 stores the generated payment token, the shop ID, the information about the amount of money to be paid, and the information about the payment target product in association with each other in a storage medium. The payment token may include one or all of individual shop information for individually identifying a shop, shop brand information for identifying a name or a brand of the shop, payment business operator information for identifying a payment business operator who holds the payment processing device 11, amount-of-money-to-be-paid information about an amount of money to be paid, and expiration date information representing an expiration date of the payment token. Furthermore, the payment processing device 11 may store a time when the payment token has been generated and the payment token in association with each other.

The payment processing device 11 transmits the generated payment token to the shop terminal 13 ((a2) in FIG. 1). The payment processing device 11 may transmit the payment token that has been encrypted to the shop terminal 13 after encrypting the payment token.

The shop terminal 13 generates a payment code on the basis of the received payment token and causes the payment code to be displayed ((a3) in FIG. 1).

The user terminal 12 reads the payment code displayed on the shop terminal 13 according to, for example, the user's imaging operation ((a4) in FIG. 1). The user terminal 12 acquires the payment token represented by the read payment code and transmits a payment request including the user ID and the payment token to the payment processing device 11 ((a5) in FIG. 1).

When the payment request is acquired from the user terminal 12, the payment processing device 11 determines whether or not the user ID included in the payment request has been registered in the payment processing device 11, compares whether or not the payment token received from the user terminal 12 is the same as the payment token transmitted to the shop terminal 13 when it is determined that the user ID has been registered, and determines whether or not the balance of the account of the user associated with the code payment serving as the first payment scheme held by the user identified by the received user ID is greater than or equal to the amount of money to be paid when it is determined that the payment tokens are the same ((a6) in FIG. 1). The payment processing device 11 uses the amount of money to be paid associated with the received payment token or the amount of money to be paid represented by the amount-of-money-to-be-paid information included in the received token, as the amount of money to be paid used for the above determination.

The payment processing device 11 performs payment of the amount of money to be paid when the balance of the account of the user associated with the code payment is greater than or equal to the amount of money to be paid and determines whether or not a second payment scheme associated with the user satisfies a predetermined condition when the balance of the account is less than the amount of money to be paid ((a7) in FIG. 1).

When it is determined that the second payment scheme satisfies the predetermined condition, the payment processing device 11 allows the balance of the account of the user in the code payment to be insufficient and performs payment of the amount of money to be paid according to the code payment ((a8) in FIG. 1). Here, the payment processing device 11 does not deposit money into the account of the user when the payment is performed. Because money is automatically deposited into an account in a payment process in which the balance is insufficient in an auto-charge process which is generally performed, it is difficult for the user to know how much money has been spent and the auto-charge process may not be suitable for a user who desires to manage an upper limit of monetary spending. On the other hand, the payment processing device 11 can allow a user who desires to manage monetary spending using a prepaid account to recognize that the balance of the account is insufficient by allowing the balance to be insufficient and performing payment of an amount of money to be paid according to the code payment without automatically depositing money into the account even if the balance is insufficient at the time of payment. Thereby, the user is allowed to easily manage monetary spending.

It is possible to perform payment even if the balance of the account of the user corresponding to the code payment is less than the amount of money to be paid by operating the payment system as described above. Thereby, because the user does not need to pay an insufficient amount of money by cash or perform the code payment again by performing a charge process when the balance of the account of the user is less than the amount of money to be paid, it is possible to reduce a burden on the user when the balance of the account is insufficient at the time of payment.

Details of components of the payment processing device 11, the user terminal 12, and the shop terminal 13 will be described below.

### [Functional Configuration of Payment Processing Device 11]

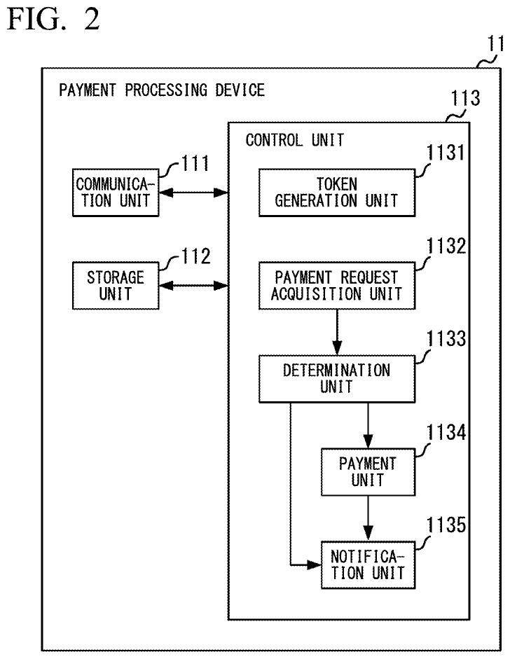

FIG. 2 is a diagram showing a functional configuration of the payment processing device 1. The payment processing device 11 includes a communication unit 111, a storage unit 112, and a control unit 113.

The communication unit 111 is a communication interface for transmitting and receiving data to and from the user terminal 12 and the shop terminal 13 via a network such as the Internet.

The storage unit 112 is a storage medium that stores various types of data, and includes a read only memory (ROM), a random access memory (RAM), a hard disk, and the like. The storage unit 112 stores a program to be executed by the control unit 113. The storage unit 112 stores a payment processing program for causing the control unit 113 to function as a token generation unit 1131, a payment request acquisition unit 1132, a determination unit 1133, a payment unit 1134, and a notification unit 1135.

Also, the storage unit 112 stores account information in which the user ID of the user is associated with the prepaid account of the user associated with the code payment. Also, the storage unit 112 stores the user ID of the user and information for identifying the second payment scheme of the user in association with each other.

For example, the second payment scheme is post-paid payment such as credit card payment or carrier payment which is a payment scheme in which a business operator who provides a communication service requests usage fees for various types of services together with a communication fee related to the use of a portable phone network. Here, a business operator who receives the payment request for the code payment is the same as a business operator who provides a service different from the code payment (a business operator who provides a communication service or a business operator who provides the second payment scheme).

Also, the information for identifying the second payment scheme includes, for example, a contract ID for identifying a contract related to the carrier payment and a card number of a credit card. Also, it is assumed that the information for identifying the second payment scheme is arbitrarily registered in the payment processing device 11 by the user and there may be users who are not associated with the information for identifying the second payment scheme among users.

The control unit 113 is, for example, a central processing unit (CPU). The control unit 113 functions as the token generation unit 1131, the payment request acquisition unit 1132, the determination unit 1133, the payment unit 1134, and the notification unit 1135 by executing the payment processing program stored in the storage unit 112. Details of the operation of each part of the control unit 113 will be described below.

### [Functional Configuration of User Terminal 12]

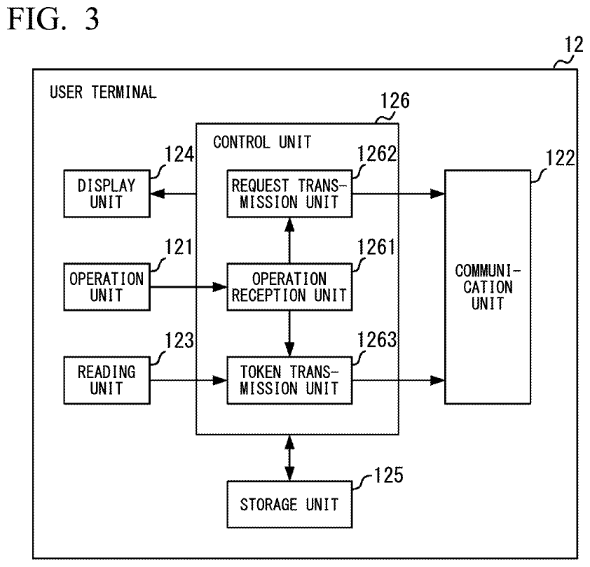

FIG. 3 is a diagram showing a functional configuration of the user terminal 12. The user terminal 12 includes an operation unit 121, a communication unit 122, a reading unit 123, a display unit 124, a storage unit 125, and a control unit 126. The control unit 126 includes an operation reception unit 1261, a request transmission unit 1262, and a token transmission unit 1263.

The operation unit 121 is an operation device that receives a user's operation, and is, for example, a touch panel provided on the surface of the display unit 124. The operation unit 121 notifies the operation reception unit 1261 of a signal representing a position touched by the user.

The communication unit 122 is, for example, a wireless communication interface for transmitting and receiving data to and from a base station of a portable phone network. The communication unit 122 transmits a payment request including the user ID and the payment token and the like to the payment processing device 11.

The reading unit 123 is, for example, a camera. The reading unit 123 reads the payment code displayed on the shop terminal 13.

The display unit 124 is a display that displays various types of information.

The storage unit 125 is a storage medium including a ROM, a RAM, and the like. The storage unit 125 stores a program to be executed by the control unit 126. The storage unit 125 stores a program for causing the control unit 126 to function as the operation reception unit 1261, the request transmission unit 1262, and the token transmission unit 1263.

The control unit 126 is, for example, a CPU, and functions as the operation reception unit 1261, the request transmission unit 1262, and the token transmission unit 1263 by executing a program stored in the storage unit 125.

The operation reception unit 1261 identifies operation content of the user on the basis of a signal input from the operation unit 121. The operation reception unit 1261 notifies the token transmission unit 1263 of the operation content when the identified operation content is an operation for reading the payment code.

The token transmission unit 1263 causes the reading unit 123 to read the payment code displayed on the shop terminal 13 when the operation reception unit 1261 has received the operation for reading the payment code. The token transmission unit 1263 acquires information extracted by the reading unit 123 from the payment code as a payment token. The token transmission unit 1263 transmits a payment request including the acquired payment token and the user ID to the payment processing device 11 via the communication unit 122.

### [Functional Configuration of Shop Terminal 13]

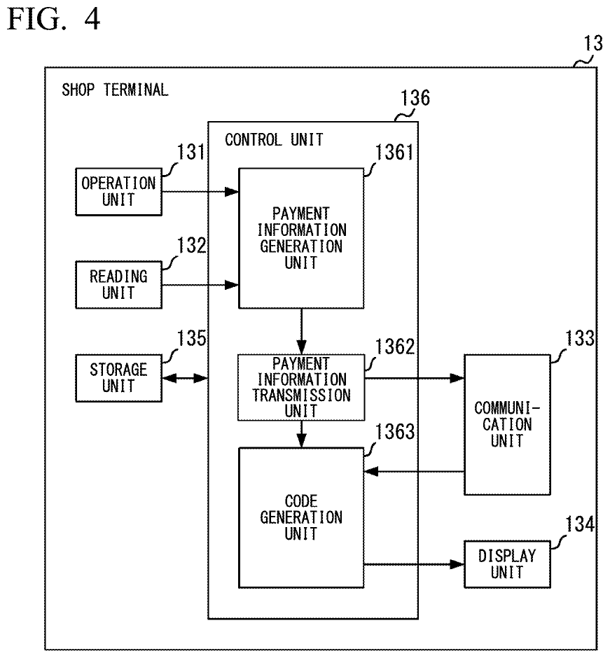

FIG. 4 is a diagram showing a functional configuration of the shop terminal 13. The shop terminal 13 includes an operation unit 131, a reading unit 132, a communication unit 133, a display unit 134, a storage unit 135, and a control unit 136.

The operation unit 131 is an operation device that receives the user's operation, and is, for example, a button for selecting a product to be purchased by the user or a touch panel provided on the surface of the display unit 134.

The reading unit 132 is, for example, a barcode reader, and reads a barcode attached to a product purchased by the user. The reading unit 132 outputs information represented by the read barcode to the control unit 136.

For example, the communication unit 133 is a communication interface for transmitting and receiving data to and from the payment processing device 11. The communication unit 133 transmits the payment code acquisition request, the payment information, and the shop ID to the payment processing device 11 in accordance with control of the control unit 136. Also, the communication unit 133 receives a payment token from the payment processing device 11.

The display unit 134 is a display that displays various types of information. The display unit 134 displays, for example, an amount of money to be paid and a payment code.

The storage unit 135 is a storage medium including a ROM, a RAM, and the like. The storage unit 135 stores a program to be executed by the control unit 136. The storage unit 135 stores a program for causing the control unit 136 to function as a payment information generation unit 1361, a payment information transmission unit 1362, and a code generation unit 1363. Also, the storage unit 135 stores a product DB in which a product ID and the price of a product are associated.

The control unit 136 is, for example, a CPU, and functions as the payment information generation unit 1361, the payment information transmission unit 1362, and the code generation unit 1363 by executing the program stored in the storage unit 135.

The payment information generation unit 1361 identifies one or more payment target products and generates payment information. Specifically, the payment information generation unit 1361 acquires a product ID input by the clerk on the operation unit 131 or a product ID read by the reading unit 132 from a barcode attached to the product, thereby identifying the product of the acquired product ID as a payment target product. The payment information generation unit 1361 identifies the price of the product associated with the acquired product ID with reference to the product DB stored in the storage unit 135. The payment information generation unit 1361 acquires one or more of a product ID input by the clerk on the operation unit 131 and a product ID read by the reading unit 132 from the barcode attached to the product and totals the price of products identified from product IDs. When the payment information generation unit 1361 receives a calculation operation in the operation unit 131, the payment information generation unit 1361 determines the total price of products as an amount of money to be paid. The payment information generation unit 1361 generates payment information including the determined amount of money to be paid. The payment information may include information about the product identified by the product ID, for example, an attribute, a name, a manufacturer, and a seller of the product.

When the payment information generation unit 1361 generates the payment information, the payment information transmission unit 1362 transmits the payment code acquisition request, the payment information, and the shop ID to the payment processing device 11 via the communication unit 133.

When the payment token is received from the payment processing device 11, the code generation unit 1363 generates a payment code based on the payment token. For example, the code generation unit 1363 generates a payment code based on a rule that has been determined in advance. The code generation unit 1363 causes the display unit 134 to display the generated payment code.

### [Operation of Each Part of Control Unit 113]

Next, an operation of each part of the control unit 113 will be described. When the payment code acquisition request, the payment information, and the shop ID are received from the shop terminal 13, the token generation unit 1131 generates a payment token for generating a payment code. For example, the storage unit 112 stores the shop ID of the shop where the code payment is available, i.e., the code payment member shop. The token generation unit 1131 determines whether or not the received shop ID has been registered as the shop ID of the code payment member shop with reference to the storage unit 112. The token generation unit 1131 generates a payment token to be transmitted to the shop terminal 13 when it is determined that the received shop ID has been registered as the shop ID of the member shop. The token generation unit 1131 causes the storage unit 112 to store the generated payment token, the payment information, and the shop ID in association with each other. Also, the token generation unit 1131 transmits the generated payment token to the shop terminal 13 that has transmitted the payment code acquisition request.

The payment request acquisition unit 1132 acquires a payment request, which includes the payment token and the user ID from the user terminal 12 that has read the payment code displayed by the shop terminal 13 on the basis of the payment token, which is a payment request for an amount of money to be paid by the user, and which corresponds to the code payment serving as the first payment scheme.

Also, the payment request acquisition unit 1132 may acquire a payment request including a payment token, a user ID, and a shop ID from the user terminal 12. For example, the shop terminal 13 causes the shop ID or a code representing the shop ID to be displayed and the user terminal 12 reads the shop ID or reads the code to extract the shop ID from the code and transmits the payment request including the shop ID to the payment processing device 11.

The determination unit 1133 determines whether or not the balance of the account of the user associated with the code payment is less than the amount of money to be paid. Specifically, the determination unit 1133 determines whether or not the payment token included in the payment request has been stored in the storage unit 112 as the payment token transmitted to the shop terminal 13. When the determination unit 1133 determines that the payment token has been stored in the storage unit 112 as the payment token transmitted to the shop terminal 13, the determination unit 1133 identifies the amount of money to be paid represented by the payment information stored in the storage unit 112 in association with the payment token. Also, when the determination unit 1133 determines that the payment token has been stored in the storage unit 112 as the payment token transmitted to the shop terminal 13, the determination unit 1133 identifies the balance of the account corresponding to the code payment of the user stored in the storage unit 112 in association with the user ID included in the payment request acquired by the payment request acquisition unit 1132. The determination unit 1133 determines whether or not the identified balance of the account of the user is less than the identified amount of money to be paid.

The determination unit 1133 determines whether or not the second payment scheme associated with the user satisfies a predetermined condition when the balance of the account of the user associated with the code payment is less than the amount of money to be paid.

The predetermined condition is, for example, that a difference in the amount of money between the amount of money to be paid and the balance of the account of the user can be paid according to the second payment scheme. That is, when the balance of the account of the user associated with the code payment is less than the amount of money to be paid, the determination unit 1133 transmits a payment limit allocation request (an authorization request) to the determination device for determining whether or not the second payment scheme is available. The determination device determines whether or not the second payment scheme is valid, whether or not an amount of money to be paid has reached a usage limit of the second payment scheme, or the like when the payment limit allocation request is received and transmits approval information representing an approval for the payment limit allocation request (an approval for authorization) to the payment processing device 11 when it is determined that payment limit allocation is possible. The determination unit 1133 determines whether or not the difference in the amount of money between the amount of money to be paid and the balance of the account of the user can be paid according to the second payment scheme associated with the user by determining whether or not the approval information representing the approval for the payment limit allocation request has been acquired from the determination device.

Also, although the predetermined condition may be that the difference in the amount of money between the amount of money to be paid and the balance of the account of the user can be paid according to the second payment scheme, the present invention is not limited thereto. The predetermined condition may be that the user is associated with the second payment scheme.

The payment unit 1134 performs payment of the amount of money to be paid. Specifically, when the balance of the account of the user is greater than or equal to the amount of money to be paid, the payment unit 1134 performs the payment by subtracting the amount of money to be paid from the balance of the account of the user corresponding to the code payment.

Also, if the determination unit 1133 determines that the second payment scheme satisfies the predetermined condition when the balance of the account of the user is less than the amount of money to be paid, the payment unit 1134 allows the balance of the account of the user in the code payment to be insufficient and performs payment of the amount of money to be paid according to the code payment.

Specifically, when the determination unit 1133 acquires the approval information representing the approval for the payment limit allocation request (the approval for authorization) from the determination device, the payment unit 1134 subtracts the amount of money to be paid identified by the determination unit 1133 from the balance of the account of the user associated with the user ID included in the payment request acquired by the payment request acquisition unit 1132. Because the balance of the account is less than the amount of money to be paid, the balance of the account after subtraction of the amount of money to be paid is less than 0 yen. Because the payment processing device 11 subtracts the amount of money to be paid in accordance with the acquisition of the approval for the payment limit allocation request from the determination device, the business operator who operates the code payment can allow the balance of the account of the user to be insufficient on the basis of the allocated payment limit.

Subsequently, the payment unit 1134 performs a process of depositing the amount of money to be paid into the account of the shop identified by the shop ID stored in the storage unit 112 in association with the payment token or the shop ID included in the payment token. Here, the payment unit 1134 may deposit an amount of money obtained by subtracting a payment fee in the payment processing device 11 from the amount of money to be paid into the account of the shop.

When the payment of the amount of money to be paid has been completed, the notification unit 1135 notifies the shop terminal 13 of payment completion information representing that the payment has been completed. Also, when the payment of the amount of money to be paid has been completed, the notification unit 1135 notifies the user terminal 12 of the payment completion information representing that the payment has been completed.

When the balance of the account of the user corresponding to the code payment is insufficient, the notification unit 1135 notifies the user of the payment completion information including information representing that the balance of the account of the user corresponding to the code payment is insufficient after the payment of the amount of money to be paid is performed by the payment unit 1134. For example, the notification unit 1135 notifies the user of the information by transmitting the payment completion information including the information representing that the balance of the account of the user corresponding to the code payment is insufficient to the user terminal 12 which is a transmission source of the payment token.

When the balance of the account of the user associated with the code payment is less than the amount of money to be paid, the notification unit 1135 may notify the user of information for prompting the user to set the second payment scheme as the payment scheme corresponding to the first payment scheme if it is determined that a difference in the amount of money between the amount of money to be paid and the balance of the account of the user can be paid according to the second payment scheme associated with the user. Thereby, the user can perform payment without delay by switching the payment scheme corresponding to the first payment scheme to a payment scheme in which payment is possible.

For example, the notification unit 1135 notifies the user of a difference in the amount of money between the balance before the payment of the amount of money to be paid is performed and the amount of money to be paid, i.e., an insufficient amount of money when the payment of the amount of money to be paid is performed, as information representing that the balance of the account of the user corresponding to the code payment is insufficient. Also, the notification unit 1135 notifies the user of information representing that the balance of the account of the user corresponding to the code payment is insufficient and information for prompting the user to deposit money into the account associated with the code payment. Thereby, the user can recognize the fact that the balance of the account of the user is insufficient and the insufficient amount of money and can deposit money into the account.

Also, the payment unit 1134 requests the cancellation of payment limit allocation in the second payment scheme when an amount of money greater than or equal to the difference in the amount of money between the balance and the amount of money to be paid is deposited into the account of the user associated with the code payment after the allocation of the payment limit corresponding to a difference in the amount of money between the balance before the amount of money to be paid is subtracted and the amount of money to be paid is requested in the second payment scheme. Here, a deposit of the amount of money may be a deposit of an amount of money into which the number of points available as consideration for the payment when the product is purchased is converted.

Also, the payment unit 1134 requests an amount of money corresponding to the payment limit in the second payment scheme when the balance of the account of the user associated with the code payment has been insufficient for a predetermined period after the allocation of the payment limit corresponding to a difference in the amount of money between the balance before the amount of money to be paid is subtracted and the amount of money to be paid is requested in the second payment scheme. In this case, the payment unit 1134 causes an insufficient state of the account balance to be eliminated by requesting the user to pay an amount of money corresponding to the payment limit and setting the account balance to 0 yen together with a request for a usage fee of a service used by the user whose payment scheme is the second payment scheme.

Here, the notification unit 1135 may be configured to notify the user that the request for the amount of money corresponding to the payment limit has been transmitted to the user together with the request for the usage fee of the service. Also, the notification unit 1135 may be configured to notify the user that the insufficient state of the account balance has been eliminated in accordance with the request for the amount of money corresponding to the payment limit transmitted to the user.

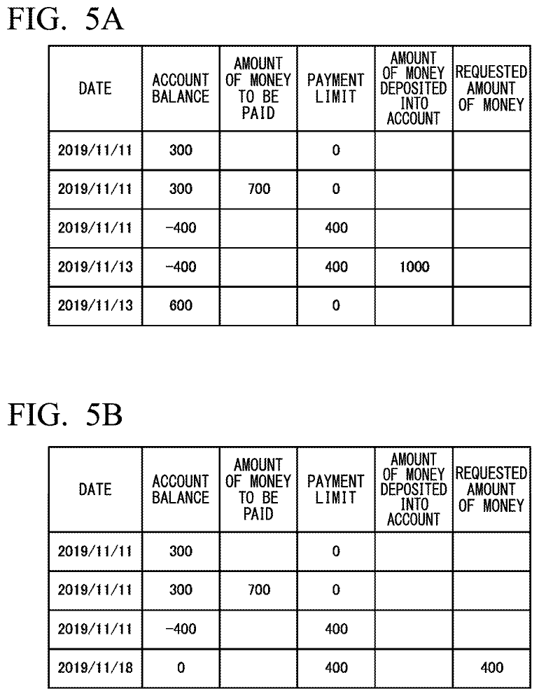

FIGS. 5A and 5B are tables showing a process of the payment processing device 11 when the balance of the account of the user in the code payment is insufficient. These tables show examples of relationships between an account balance, an amount of money to be paid, a payment limit of the second payment scheme, an amount of money deposited into the account, and a requested amount of money of the second payment scheme, which are set by the payment processing device 11. FIG. 5A shows an example in which money has been deposited into the account within a predetermined period after the balance of the account of the user in the code payment became insufficient. FIG. 5B shows an example in which no money has been deposited into the account within the predetermined period after the balance of the account of the user in the code payment became insufficient. The unit of the amount of money shown in FIGS. 5A and 5B is yen.

For example, as shown in FIGS. 5A and 5B, it is assumed that the balance of the account of the user in the code payment before the user purchases the product is 300 yen and the amount of money to be paid when the product is purchased is 700 yen. In this case, the payment unit 1134 allows the balance of the account of the user in the code payment to be insufficient, performs payment of the amount of money to be paid according to the code payment, and requests the allocation of the payment limit of the amount of money corresponding to the difference between the balance before the amount of money to be paid is subtracted and the amount of money to be paid in the second payment scheme. Thereby, the balance of the account becomes −400 yen and 400 yen is allocated as the payment limit.

Thereafter, as shown in FIG. 5A, if 1000 yen is deposited into the account of the user in the code payment within a predetermined period, the balance of the account becomes 600 yen, the insufficient state is eliminated, the allocation of the payment limit is cancelled, and an amount of money of the allocated payment limit becomes 0 yen.

On the other hand, as shown in FIG. 5B, when there is no deposit in the account of the user in the code payment within the predetermined period, an insufficient amount of money (400 yen) in the balance of the account is requested in the second payment scheme. Also, the balance of the account is changed to 0 yen in response to the request in the second payment scheme.

### [Flow of Process in Payment Processing Device 11]

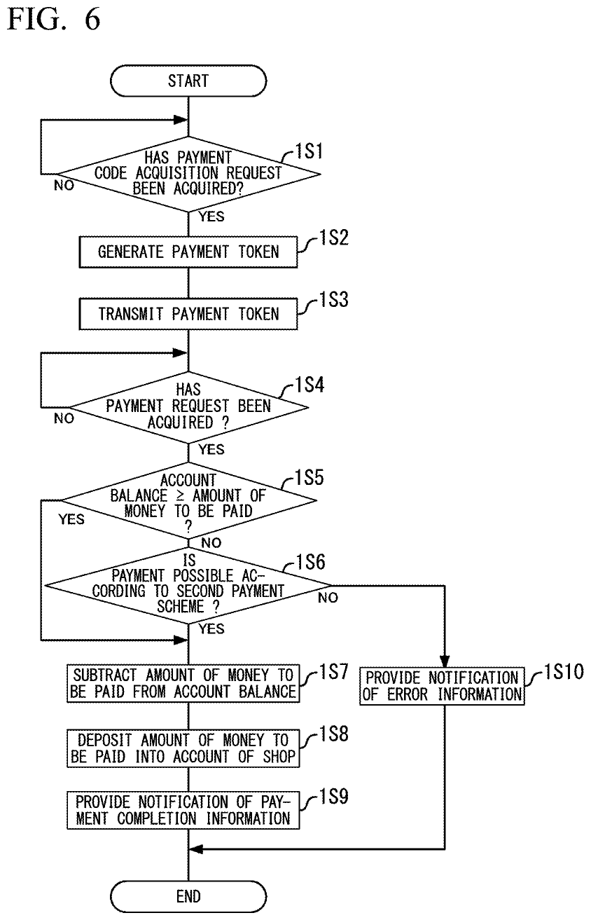

Next, a flow of a process of the payment processing device 11 will be described. First, a flow of a process until the payment processing device 11 performs payment will be described. FIG. 6 is a flowchart showing the flow of the process until the payment processing device 11 performs the payment.

First, the token generation unit 1131 determines whether or not a payment code acquisition request has been acquired from the shop terminal 13 (step 1S1). The process moves to step 1S2 if the token generation unit 1131 determines that the payment code acquisition request has been acquired and step 1S1 is executed again if the token generation unit 1131 determines that no payment code acquisition request has been acquired.

Subsequently, the token generation unit 1131 generates a payment token (step 1S2) and causes the storage unit 112 to store the payment token and the payment information and the shop ID acquired together with the payment code acquisition request in association with each other. The token generation unit 1131 transmits the generated payment token to the shop terminal 13 (step 1S3).

When the payment token is received from the payment processing device 11, the code generation unit 1363 of the shop terminal 13 generates a payment code based on the payment token and causes the display unit 34 to display the payment code. When the payment code displayed on the shop terminal 13 is read, the token transmission unit 1263 of the user terminal 12 transmits a payment request including the payment token and the user ID to the payment processing device 11.

The payment request acquisition unit 1132 determines whether or not the payment request including the payment token and the user ID has been acquired from the user terminal 12 (step 1S4). The process moves to step 1S5 if the payment request acquisition unit 1132 determines that the payment request has been acquired and step 1S4 is executed again if the payment request acquisition unit 1132 determines that no payment request has been acquired.

In step 1S5, when the payment request is acquired, the determination unit 1133 determines whether or not the account balance in the code payment of the user with the user ID included in the payment request is greater than or equal to the amount of money to be paid. The process moves to step 1S7 if the determination unit 1133 determines that the account balance is greater than or equal to the amount of money to be paid and the process moves to step 1S6 if the determination unit 1133 determines that the account balance is less than the amount of money to be paid.

In step 1S6, the determination unit 1133 requests the determination device, which determines whether or not the second payment scheme is available, to allocate a payment limit corresponding to an amount of money of a difference between the amount of money to be paid and the balance of the account of the user so as to determine whether or not the difference in the amount of money can be paid according to the second payment scheme associated with the user. The process moves to step 1S7 if the determination unit 1133 determines that the difference in the amount of money can be paid and the process moves to step 1S10 if the determination unit 1133 determines that the difference in the amount of money cannot be paid according to the second payment scheme.

In step 1S7, the payment unit 1134 performs the payment of the amount of money to be paid according to code payment. Here, when it is determined that the balance of the account associated with the code payment is less than the amount of money to be paid in step 1S5, the payment unit 1134 allows the balance of the account of the user in the code payment to be insufficient and subtracts the amount of money to be paid from the balance of the account.

Subsequently, the payment unit 1134 executes a process of depositing the amount of money to be paid into the account of the shop identified by the shop ID stored in the storage unit 112 in association with the payment token (step 1S8).

Subsequently, the notification unit 1135 notifies the user terminal 12 of payment completion information representing that the payment has been completed (step 1S9). Here, when the balance of the account of the user corresponding to the code payment is insufficient, the notification unit 1135 notifies the user terminal 12 of payment completion information including information representing that the balance of the account is insufficient.

On the other hand, when it is determined that the difference in the amount of money cannot be paid according to the second payment scheme in step 1S6, the notification unit 1135 notifies the user terminal 12 of error information representing that the amount of money to be paid cannot be paid according to the code payment (step 1S10).

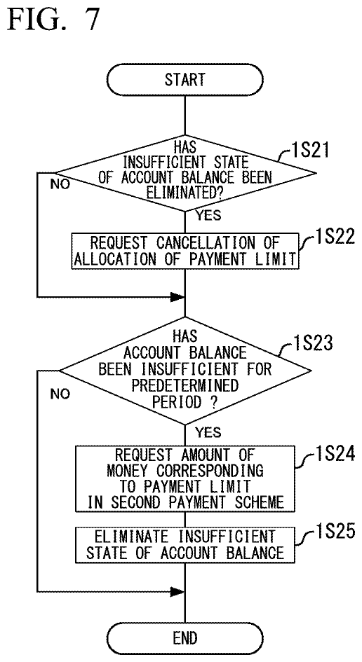

Next, the flow of a process of the payment processing device 11 when the balance of the account associated with the code payment is in an insufficient state will be described. FIG. 7 is a flowchart showing the flow of the process of the payment processing device 11 when the balance of the account associated with the code payment is in the insufficient state. Also, it is assumed that the present flowchart is executed every predetermined time period (for example, one day).

The payment unit 1134 determines whether or not the insufficient state of the balance of the account has been eliminated by depositing money into the account whose balance is in the insufficient state in a charge process (step 1S21). The process moves to step 1S22 if the payment unit 1134 determines that the insufficient state has been eliminated and the process moves to step 1S23 if the payment unit 1134 determines that the insufficient state has not been eliminated.

In step 1S22, the payment unit 1134 requests the cancellation of the allocation of the payment limit, which has been allocated in step 1S6 of FIG. 6, in the second payment scheme.

In step 1S23, the payment unit 1134 determines whether or not the balance of the account associated with the code payment has been insufficient for a predetermined period. The process moves to step 1S24 if the payment unit 1134 determines that the account balance has been insufficient for the predetermined period and the process related to the present flowchart ends if the payment unit 1134 determines that the account balance has not been insufficient for the predetermined period.

In step 1S24, the payment unit 1134 requests an amount of money corresponding to the payment limit allocated in step 1S6 of FIG. 6 in the second payment scheme.

Subsequently, the payment unit 1134 causes the insufficient state of the account balance to be eliminated (step 1S25).

### MODIFIED EXAMPLE 1-1

Although the shop terminal 13 has requested the payment processing device 11 to acquire a payment code when the user purchases a product in the above description, the present invention is not limited thereto. For example, when only products with the same amount of money are handled in the shop and the amount of money of the product purchased by the user is uniform, the shop terminal 13 may receive a payment token from the payment processing device 11 in advance and cause a payment code corresponding to the payment token to be displayed. The payment processing device 11 may acquire a payment request from the user terminal 12 that has read the payment code and perform a payment process.

### MODIFIED EXAMPLE 1-2

Also, although an example in which the shop terminal 13 displays the payment code, the user terminal 12 reads the payment code displayed on the shop terminal 13 and transmits the payment request to the payment processing device 11 has been shown in the above description, the present invention is not limited thereto. For example, the user terminal 12 may display the payment code and the shop terminal 13 may read the payment code and transmit the payment request to the payment processing device 11.

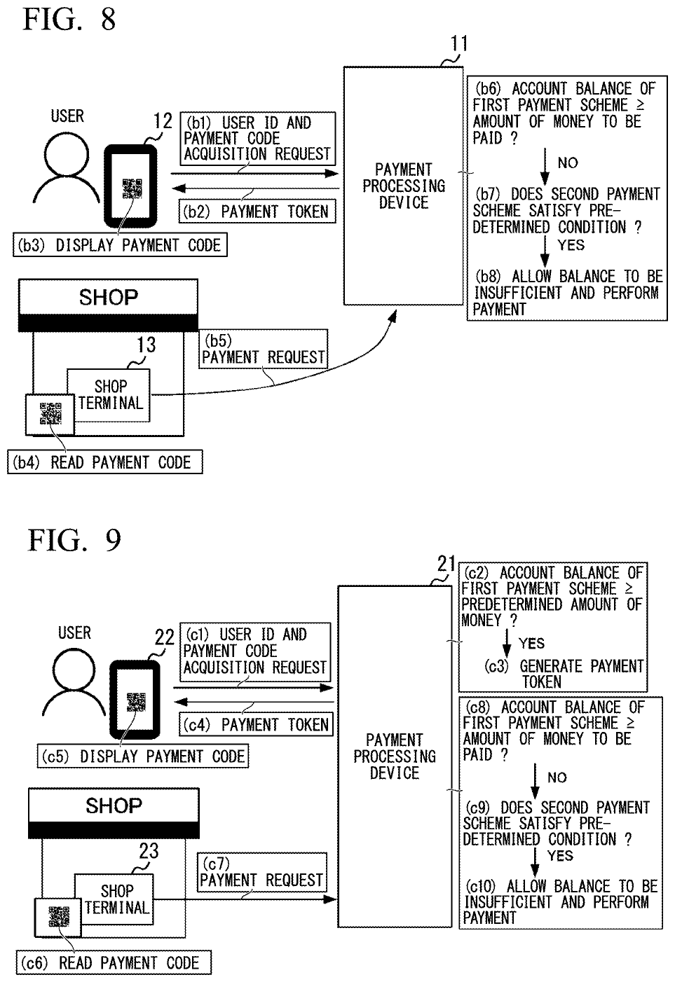

FIG. 8 is a diagram showing a flow of a process when the shop terminal 13 transmits a payment request to the payment processing device 11. As shown in FIG. 8, the user of the user terminal 12 performs an operation for causing the user terminal 12 to display the payment code when purchasing a product in a shop. The user terminal 12 transmits a payment code acquisition request and a user ID to the payment processing device 11 ((b1) in FIG. 8).

When the payment code acquisition request and the user ID are received from the user terminal 12, the token generation unit 1131 of the payment processing device 11 generates a payment token and stores the generated payment token and the user ID in association with each other in the storage medium. Also, the payment processing device 11 transmits the generated payment token to the user terminal 12 ((b2) in FIG. 8).

The user terminal 12 generates a payment code on the basis of the received payment token and causes the payment code to be displayed ((b3) in FIG. 8). The shop terminal 13 reads the payment code displayed on the user terminal 12 according to, for example, an operation of the clerk ((b4) in FIG. 8). The shop terminal 13 transmits a payment request including a shop ID, payment information including an amount of money to be paid by the user, and a payment token represented by the read payment code to the payment processing device 11 ((b5) in FIG. 8).

The payment request acquisition unit 1132 of the payment processing device 11 acquires a payment request corresponding to the code payment from the shop terminal 13 to which the amount of money to be paid is paid by the user. When the payment request acquisition unit 1132 acquires the payment request, the determination unit 1133 of the payment processing device 11 determines whether or not the balance of the account of the user associated with the first payment scheme is greater than or equal to the amount of money to be paid ((b6) in FIG. 8). The payment unit 1134 of the payment processing device 11 performs payment of the amount of money to be paid when the balance of the account of the user corresponding to the code payment is greater than or equal to the amount of money to be paid.

Also, when the balance of the account is less than the amount of money to be paid, the determination unit 1133 determines whether or not the second payment scheme associated with the user corresponding to the user ID associated with the payment token included in the payment request satisfies a predetermined condition ((b7) in FIG. 8). When the determination unit 1133 determines that the second payment scheme satisfies the predetermined condition, the payment unit 1134 allows the balance of the account of the user corresponding to the code payment to be insufficient and performs payment of an amount of money to be paid according to the code payment ((b8) in FIG. 8).

### MODIFIED EXAMPLE 1-3

Also, although the first payment scheme is code payment in the above description, the present invention is not limited thereto. The first payment scheme may be a prepaid payment scheme in which the balance is managed on a server side such as the payment processing device 11 or a payment scheme in which the amount of money to be paid is withdrawn from a bank account (a debit scheme). In this case, the payment unit 1134 may allow the balance of the account corresponding to the first payment scheme to be insufficient and perform payment of an amount of money to be paid according to the first payment scheme.

### [Effect of Payment System]

As described above, the payment processing device 11 acquires a payment request corresponding to the code payment serving as the first payment scheme with respect to an amount of money to be paid by the user and determines whether or not the second payment scheme associated with the user satisfies a predetermined condition when the balance of the account of the user associated with the code payment is less than the amount of money to be paid. If it is determined that the second payment scheme satisfies the predetermined condition, the payment processing device 11 allows the balance of the account of the user in the code payment to be insufficient and performs payment of the amount of money to be paid according to the code payment. Thereby, the user can reduce the burden on the user when the account balance is insufficient at the time of payment.

### Second Embodiment

### [Outline of Payment Processing Device 21]

FIG. 9 is a diagram showing an outline of a payment processing device 21. The payment processing device 21 is a computer that performs payment in accordance with reception of a payment code corresponding to an amount of money to be paid for a product from a user terminal 22 or a shop terminal 23 when a user purchases the product. The payment code is text or an image that can be read by the user terminal 22 or the shop terminal 23 and is a code used at the time of payment.

The payment processing device 21 is connected to the user terminal 22 and the shop terminal 23 via communication networks such as a portable phone network and the Internet. The user terminal 22 is a portable terminal used by the user, and is, for example, a smartphone, a wearable device, a tablet, or a personal computer. The shop terminal 23 is, for example, a POS terminal.

Hereinafter, a flow until payment for the price of a product is performed will be described with reference to an example in which payment is performed according to code payment. FIG. 9 shows an example in which payment is performed in accordance with the fact that the payment processing device 21 identifies that the shop terminal 23 has read a payment code. Also, in the present embodiment, a payment scheme for paying an amount of money is associated with the code payment serving as the first payment scheme in the payment processing device 21. In the present embodiment, it is assumed that a prepaid account payment scheme in which the balance is managed in a prepaid account and the amount of money to be paid is paid from the balance is associated with the payment scheme associated with the first payment scheme. The prepaid account may be associated with a prepaid card owned by the user.

First, the user performs an operation for causing the user terminal 22 to display the payment code when purchasing a product in the shop. The user terminal 22 transmits a payment code acquisition request and a user ID to the payment processing device 21 ((c1) in FIG. 9).

When the payment code acquisition request and the user ID is received from the user terminal 22, the payment processing device 21 determines whether or not the account of the user associated with the code payment serving as the first payment scheme associated with the user ID satisfies a first condition (a predetermined condition) representing a state in which payment is possible. Here, the first condition is that the balance of the account is greater than or equal to a predetermined amount of money. That is, the payment processing device 21 determines whether or not the balance of the account of the user is greater than or equal to the predetermined amount of money ((c2) in FIG. 9).

When it is determined that the balance of the account of the user is greater than or equal to the predetermined amount of money, the payment processing device 21 generates a payment token ((c3) in FIG. 9). Here, the predetermined amount of money is, for example, 0 yen. The payment token is a one-time data string that is issued with respect to a code acquisition request and is used when the user terminal 22 generates a payment code to be presented to the shop by the user. The payment processing device 21 stores the generated payment token and the user ID in association with each other in a storage medium. The payment token may include at least one of payment business operator information for identifying a payment business operator who holds the payment processing device 21 and expiration date information representing an expiration date of the payment token. Also, the payment processing device 21 may store a time when the payment token has been generated and the payment token in association with each other.

The payment processing device 21 transmits the generated payment token to the user terminal 22 ((c4) in FIG. 9). The payment processing device 21 may transmit the payment token that has been encrypted to the user terminal 22 after encrypting the payment token.

The user terminal 22 generates a payment code on the basis of the received payment token and causes the payment code to be displayed ((c5) in FIG. 9).

The shop terminal 23 reads the payment code displayed on the user terminal 22 according to, for example, an imaging operation of a clerk ((c6) in FIG. 9). The shop terminal 23 transmits a payment request including the shop ID, the payment information including the amount of money to be paid by the user, and the payment token represented by the read payment code to the payment processing device 21 ((c7) in FIG. 9). The payment information may include information about a payment target product. Also, the shop ID may be information for identifying an individual terminal installed within the shop. Also, the shop ID may include shop brand information for identifying the name and the brand of the shop.

When the payment processing device 21 acquires the payment request from the shop terminal 23, it is determined whether or not the payment processing device 21 has registered the shop identified by the shop ID included in the received payment request as a shop where code payment is available (a code payment member shop) and the balance of the account of the user corresponding to the code payment serving as the first payment scheme associated with the payment token is identified when it is determined that the shop has been registered as a code payment member shop. The payment processing device 21 determines whether or not the balance of the account of the user corresponding to the code payment serving as the first payment scheme associated with the payment token included in the payment request is greater than or equal to the amount of money to be paid ((c8) in FIG. 9). The payment processing device 21 uses the amount of money to be paid represented by the payment information included in the received payment request as the amount of money to be paid used for the above determination.

The payment processing device 21 performs payment of the amount of money to be paid when the balance of the account of the user corresponding to the code payment is greater than or equal to the amount of money to be paid and determines whether or not a second payment scheme associated with the user satisfies a second condition when the balance of the account is less than the amount of money to be paid ((c9) in FIG. 9).

When it is determined that the second payment scheme satisfies the second condition, the payment processing device 21 allows the balance of the account of the user in the code payment to be insufficient and performs payment of the amount of money to be paid according to the code payment ((c10) of FIG. 9). Here, the payment processing device 21 does not deposit money into the account of the user when payment is executed. Thereby, the balance of the account of the user becomes less than 0 yen. Also, although an example in which the balance of the account of the user is less than 0 yen will be described in the present embodiment, the present invention is not limited thereto. The balance of the account of the user may be set to 0 yen, the balance in the debt of the user may be managed, and information representing that the user is in debt may be associated together.

Subsequently, when the user purchases the product in a state in which the balance of the account of the user is less than 0 yen and the user performs an operation for causing the user terminal 22 to display the payment code, the user terminal 22 transmits a payment code acquisition request and a user ID to the payment processing device 21 ((c1) in FIG. 9).

When the payment code acquisition request and the user ID are received from the user terminal 22, the payment processing device 21 determines whether or not the balance of the account of the user associated with the code payment serving as the first payment scheme associated with the user ID is greater than or equal to a predetermined amount of money ((c2) in FIG. 9). Here, because the balance of the account of the user is less than 0 yen, the payment processing device 21 does not generate the payment token and transmits an error message representing that the payment code cannot be displayed to the user terminal 22. The user terminal 22 causes the received error message to be displayed.

The payment processing device 21 can promptly interrupt the payment when there is a high possibility that the account balance will be insufficient at the time of payment by performing the operation as described above. Thereby, the user can promptly take an action such as switching to payment in cash or depositing money into the account.

Also, because money is automatically deposited into an account in a payment process in which the balance is insufficient in an auto-charge process which is generally performed, it is difficult for the user to know how much money has been spent and the auto-charge process may not be suitable for a user who desires to manage an upper limit of monetary spending. On the other hand, the payment processing device 21 allows the balance to be insufficient without automatically depositing money into the account even if the balance is insufficient at the time of payment, performs payment of an amount of money to be paid according to the code payment, and displays an error message representing that the payment code cannot be displayed at the time of payment from the next time. Thereby, it is possible to allow a user who desires to manage monetary spending using a prepaid account to recognize that the balance of the account is insufficient. Thereby, the user is allowed to easily manage monetary spending.

Details of a configuration of the payment processing device 21, the user terminal 22, and the shop terminal 23 will be described below.

### [Functional Configuration of Payment Processing Device 21]

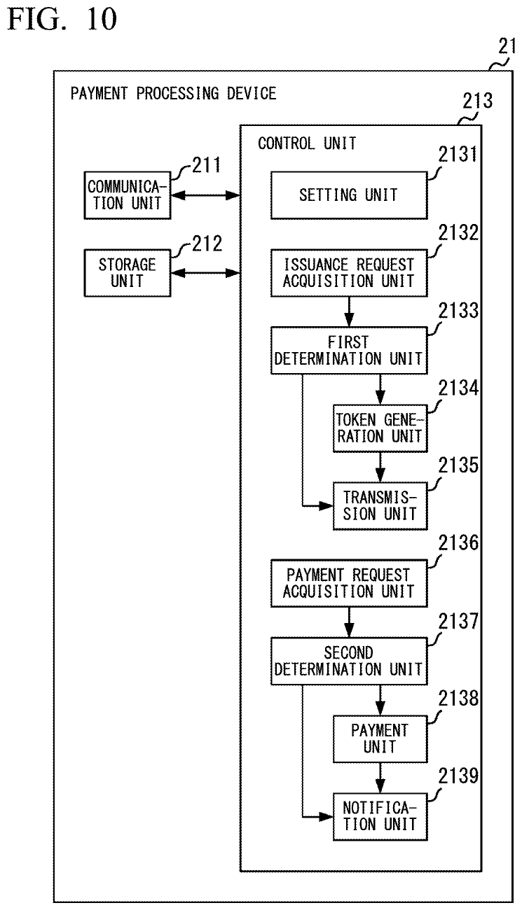

FIG. 10 is a diagram showing a functional configuration of the payment processing device 21. The payment processing device 21 includes a communication unit 211, a storage unit 212, and a control unit 213.

The communication unit 211 is a communication interface for transmitting and receiving data to and from the user terminal 22 and the shop terminal 23 via a network such as the Internet.

The storage unit 212 is a storage medium that stores various types of data and includes a ROM, a RAM, a hard disk, and the like. The storage unit 212 stores a program to be executed by the control unit 213. The storage unit 212 stores a payment processing program for causing the control unit 213 to function as a setting unit 2131, a issuance request acquisition unit 2132, a first determination unit 2133, a token generation unit 2134, a transmission unit 2135, a payment request acquisition unit 2136, a second determination unit 2137, a payment unit 2138, and a notification unit 2139.

Also, the storage unit 212 stores account information in which a user ID of the user is associated with the prepaid account of the user associated with the code payment. Also, the storage unit 212 stores the user ID of the user and the information for identifying the second payment scheme of the user in association with each other.

For example, the second payment scheme is post-paid payment such as credit card payment or carrier payment which is a payment scheme in which a business operator who provides a communication service requests usage fees for various types of services together with a communication fee related to the use of a portable phone network. Here, a business operator who receives the payment request for the code payment is the same as a business operator who provides a service different from the code payment (a business operator who provides a communication service or a business operator who provides the second payment scheme).

Also, the information for identifying the second payment scheme includes, for example, a contract ID for identifying a contract related to the carrier payment and a card number of a credit card. Also, it is assumed that the information for identifying the second payment scheme is arbitrarily registered in the payment processing device 21 by the user and there is a user who is not associated with the information for identifying the second payment scheme among users.

The control unit 213 is, for example, a CPU. The control unit 213 functions as the setting unit 2131, the issuance request acquisition unit 2132, the first determination unit 2133, the token generation unit 2134, the transmission unit 2135, the payment request acquisition unit 2136, the second determination unit 2137, the payment unit 2138, and the notification unit 2139 by executing the payment processing program stored in the storage unit 212. Details of the operation of each part of the control unit 213 will be described below.

### [Functional Configuration of User Terminal 22]

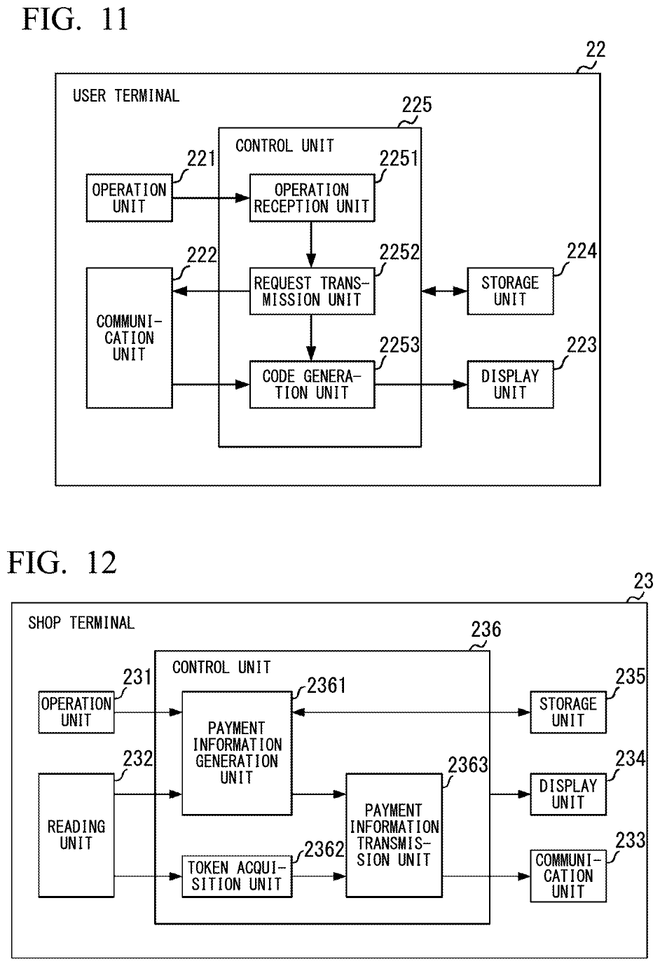

FIG. 11 is a diagram showing a functional configuration of the user terminal 22. The user terminal 22 includes an operation unit 221, a communication unit 222, a display unit 223, a storage unit 224, and a control unit 225. The control unit 225 includes an operation reception unit 2251, a request transmission unit 2252, and a code generation unit 2253.

The operation unit 221 is an operation device that receives the user's operation, and is, for example, a touch panel provided on the surface of the display unit 223. The operation unit 221 notifies the operation reception unit 2251 of a signal representing a position touched by the user.

The communication unit 222 is, for example, a wireless communication interface for transmitting and receiving data to and from a base station of a portable phone network. The communication unit 222 inputs the payment token and the like received from the payment processing device 21 to the code generation unit 2253.

The display unit 223 is a display that displays various types of information. The display unit 223 displays the payment code on the basis of control of the code generation unit 2253.

The storage unit 224 is a storage medium including a ROM, a RAM, and the like. The storage unit 224 stores a program to be executed by the control unit 225. The storage unit 224 stores a program for causing the control unit 225 to function as the operation reception unit 2251, the request transmission unit 2252, and the code generation unit 2253. Also, the storage unit 224 stores a payment token received from the payment processing device 21, a payment code generated on the basis of the payment token, and the like.

The control unit 225 is, for example, a CPU, and functions as the operation reception unit 2251, the request transmission unit 2252, and the code generation unit 2253 by executing the program stored in the storage unit 224.

The operation reception unit 2251 identifies operation content of the user on the basis of the signal input from the operation unit 221. When the identified operation content is an operation for causing the user terminal 22 to display the payment code, the operation reception unit 2251 notifies the request transmission unit 2252 of the operation content. When the operation reception unit 2251 has received the operation for causing the user terminal 22 to display the payment code, the request transmission unit 2252 transmits a user ID and a payment code acquisition request to the payment processing device 21 via the communication unit 222.

When the payment token transmitted by the payment processing device 21 is received, the code generation unit 2253 generates a payment code based on the payment token. The code generation unit 2253 generates a payment code on the basis of, for example, a rule that has been determined in advance. The code generation unit 2253 causes the display unit 223 to display the generated payment code.

### [Functional Configuration of Shop Terminal 23]

FIG. 12 is a diagram showing a functional configuration of the shop terminal 23. The shop terminal 23 is, for example, a POS terminal, and includes an operation unit 231, a reading unit 232, a communication unit 233, a display unit 234, a storage unit 235, and a control unit 236.

The operation unit 231 is an operation device that receives the user's operation, and is, for example, a button for selecting a product to be purchased by the user or a touch panel provided on the surface of the display unit 234.

The reading unit 232 is, for example, a barcode reader and a camera, and reads a barcode attached to a product purchased by the user and a payment code displayed on the user terminal 22. The reading unit 232 outputs information represented by the read barcode and the read payment code to the control unit 236.

The communication unit 233 is, for example, a communication interface for transmitting and receiving data to and from the payment processing device 21. The communication unit 233 transmits a payment request including a payment token, payment information, and a shop ID to the payment processing device 21 in accordance with control of the control unit 236.

The display unit 234 is a display that displays various types of information. For example, the display unit 234 displays an amount of money to be paid.

The storage unit 235 is a storage medium including a ROM, a RAM, and the like. The storage unit 235 stores a program to be executed by the control unit 236. The storage unit 235 stores a program for causing the control unit 236 to function as a payment information generation unit 2361, a token acquisition unit 2362, and a payment information transmission unit 2363. Also, the storage unit 235 stores a product DB in which a product ID is associated with the price of a product.

The control unit 236 is, for example, a CPU, and functions as the payment information generation unit 2361, the token acquisition unit 2362, and the payment information transmission unit 2363 by executing the program stored in the storage unit 235.

The payment information generation unit 2361 identifies one or more payment target products and generates payment information. Specifically, the payment information generation unit 2361 acquires a product ID input by the clerk in the operation unit 231 or a product ID read by the reading unit 232 from a barcode attached to a product, thereby identifying the product of the acquired product ID as a payment target product. The payment information generation unit 2361 identifies the price of the product associated with the acquired product ID with reference to the product DB stored in the storage unit 235. The payment information generation unit 2361 acquires one or more of product IDs input by the clerk in the operation unit 231 or product IDs read by the reading unit 232 from barcodes attached to products and calculates the total price of the products identified from the product IDs. When a calculation operation is received in the operation unit 231, the payment information generation unit 2361 determines the total price of the products as the amount of money to be paid. The payment information generation unit 2361 generates payment information including the determined amount of money to be paid. The payment information may include information about the product identified by the product ID, for example, an attribute, a name, a manufacturer, and a seller of the product.

The token acquisition unit 2362 acquires the information extracted from the payment code as the payment token when the reading unit 232 reads the payment code displayed on the user terminal 22.

When the payment information generation unit 2361 generates the payment information and the token acquisition unit 2362 acquires the payment token, the payment information transmission unit 2363 transmits the payment token, the payment information, and the shop ID to the payment processing device 21 via the communication unit 233.

### [Operation of Each Part of Control Unit 213]

Next, an operation of each part of the control unit 213 will be described.

The setting unit 2131 sets a predetermined amount of money used for determining whether or not to cause the user terminal 22 to display a payment code of code payment. For example, the setting unit 2131 acquires information for setting a predetermined amount of money from a business operator who provides a service related to the code payment and sets the predetermined amount of money on the basis of the information. The setting unit 2131 causes the storage unit 212 to store information representing the predetermined amount of money.

Also, the setting unit 2131 may set a predetermined amount of money by designating an amount of money, which has been determined in advance, as an upper limit. Thereby, the payment processing device 21 can restrict a process of preventing the payment code from being displayed, regardless of the fact that the balance of the account exceeds the amount of money to be paid.

Also, although the predetermined amount of money is common to a plurality of users, the present invention is not limited thereto. The predetermined amount of money may differ according to each of the plurality of users. in this case, the setting unit 2131 may acquire a user ID and information for setting the predetermined amount of money from the user terminal 22 via the communication unit 211 and set the predetermined amount of money on the basis of the information. When the setting unit 2131 acquires the user ID and the information for setting the predetermined amount of money, the setting unit 2131 may be configured to cause the storage unit 212 to store the user ID and the information representing the predetermined amount of money in association with each other. In this case, the setting unit 2131 may set a predetermined amount of money corresponding to a user who has not set the predetermined amount of money as a predetermined amount of money set by the business operator that provides a service related to the code payment.

The issuance request acquisition unit 2132 acquires a user ID for identifying a user who has issued a payment code issuance request in association with the code payment from the user terminal 22. Specifically, the issuance request acquisition unit 2132 acquires the user ID by acquiring the payment code issuance request including the user ID from the user terminal 22.

The first determination unit 2133 determines whether or not the account associated with the code payment of the user corresponding to the user ID acquired by the issuance request acquisition unit 2132 satisfies a first condition representing a state in which payment is possible. The first condition is that the balance of the account is greater than or equal to the predetermined amount of money set by the setting unit 2131. The first determination unit 2133 determines whether or not the balance of the account associated with the code payment of the user corresponding to the user ID acquired by the issuance request acquisition unit 2132 is greater than or equal to the predetermined amount of money set by the setting unit 2131.

Specifically, first, the first determination unit 2133 identifies the balance of the account of the user stored in the storage unit 212 in association with the user ID acquired by the issuance request acquisition unit 2132. Also, the first determination unit 2133 identifies the predetermined amount of money corresponding to the user ID acquired by the issuance request acquisition unit 2132. For example, the first determination unit 2133 determines whether or not information representing a predetermined amount of money in association with the user ID acquired by the issuance request acquisition unit 2132 has been stored in the storage unit 212. When the information representing the predetermined amount of money in association with the user ID has been stored in the storage unit 212, the first determination unit 2133 identifies the predetermined amount of money on the basis of the information. When the storage unit 212 has not stored the information representing the predetermined amount of money in association with the user ID, the first determination unit 2133 identifies the predetermined amount of money set by the business operator that provides the service related to the code payment. The first determination unit 2133 determines whether or not the identified balance of the account is greater than or equal to the identified predetermined amount of money.

The token generation unit 2134 does not generate a payment token related to a code corresponding to the user displayed on the user terminal 22 when the first determination unit 2133 determines that the account of the user does not satisfy the first condition and generates the payment token when the first determination unit 2133 determines that the account of the user satisfies the first condition. Specifically, the token generation unit 2134 does not cause the user terminal 22 to display the payment code corresponding to the user when the first determination unit 2133 determines that the balance of the account of the user is less than the predetermined amount of money and causes the user terminal 22 to display the payment code corresponding to the user when the first determination unit 2133 determines that the balance of the account of the user is greater than or equal to the predetermined amount of money. Also, the token generation unit 2134 and the transmission unit 2135 function as a notification unit and notify the user that the balance is insufficient when the first determination unit 2133 determines that the balance of the account of the user is less than the predetermined amount of money.

More specifically, first, the token generation unit 2134 generates a payment token for generating a payment code when it is determined that the balance of the account of the user is greater than or equal to the predetermined amount of money. The token generation unit 2134 causes the storage unit 212 to store the generated payment token and the user ID in association with each other. When the token generation unit 2134 generates the payment token, the transmission unit 2135 transmits the payment token to the user terminal 22 that has transmitted the payment code issuance request and causes the user terminal 22 to display the payment code.

Also, the token generation unit 2134 generates insufficient balance information representing that the balance is insufficient when it is determined that the balance of the account of the user is less than the predetermined amount of money. The insufficient balance information includes a current account balance and a message representing that the payment code is not displayed because the balance is insufficient.

When the token generation unit 2134 generates the insufficient balance information, the transmission unit 2135 transmits the insufficient balance information to the user terminal 22 that has transmitted the payment code issuance request, thereby causing the insufficient balance information to be displayed without causing the user terminal 22 to display the payment code. Thereby, the user can recognize that the payment code is not displayed because the balance is insufficient and take an action such as payment in cash or depositing money into the account.

Also, although the token generation unit 2134 and the transmission unit 2135 notify the user that the balance is insufficient when the first determination unit 2133 determines that the balance of the account of the user is less than the predetermined amount of money, the present invention is not limited thereto. When the first determination unit 2133 determines that the balance of the account of the user is less than the predetermined amount of money, the token generation unit 2134 and the transmission unit 2135 may notify the user of information for prompting the user to deposit money into the account. In this case, the token generation unit 2134 includes information for prompting the user to deposit money into the account in the insufficient balance information and the transmission unit 2135 transmits the insufficient balance information to the user terminal 22.

Also, although the token generation unit 2134 and the transmission unit 2135 do not cause the user terminal 22 to display the payment code corresponding to the user when the first determination unit 2133 determines that the balance of the account of the user is less than the predetermined amount of money, the present invention is not limited thereto. When the user performs a setting operation so that money is automatically deposited into the account when the balance of the account becomes a set amount of money less than the predetermined amount of money, the token generation unit 2134 and the transmission unit 2135 may be configured to cause the user terminal 22 to display the payment code corresponding to the user.

For example, when the user has set the predetermined amount of money to 2000 yen and has set an auto-charge process of automatically depositing money into the account when the balance of the account is less than 1000 yen, the token generation unit 2134 generates the payment token even if the balance of the account is less than the predetermined amount of money. When the token generation unit 2134 generates the payment token, the transmission unit 2135 transmits the payment token to the user terminal 22 and causes the user terminal 22 to display the payment code. Thereby, the payment processing device 21 can prevent a process in which the payment code is not displayed and the code payment cannot be performed, regardless of the fact that the lack of the balance is likely to be eliminated in the auto-charge process, when the user has set the auto-charge process.

The payment request acquisition unit 2136 acquires a payment request corresponding to the code payment serving as the first payment scheme from the shop terminal 23 that has read the payment code displayed by the user terminal 22 on the basis of the payment token, wherein the payment request is a payment request including the shop ID, the payment information including the amount of money to be paid by the user, and the payment token represented by the payment code.

The second determination unit 2137 determines whether or not the balance of the account of the user corresponding to the code payment stored in the storage unit 212 in association with the payment token included in the payment request is less than the amount of money to be paid. Specifically, the second determination unit 2137 determines whether or not the shop ID included in the payment request acquired by the payment request acquisition unit 2136 has been registered as a shop ID of the code payment member shop. For example, the storage unit 212 stores a shop ID of a shop where the code payment is available, i.e., the shop ID of the code payment member shop. The second determination unit 2137 determines whether or not the shop ID included in the payment request has been registered as the shop ID of the code payment member shop with reference to the storage unit 212. When the second determination unit 2137 determines that the shop ID has been registered as the shop ID of the member shop, the balance of the account of the user corresponding to the code payment stored in the storage unit 212 in association with the payment token included in the payment request is identified. When the balance of the account of the user is less than the amount of money to be paid, the second determination unit 2137 determines whether or not the second payment scheme associated with the user satisfies a second condition.

For example, the second condition is that a difference in the amount of money between the amount of money to be paid and the balance of the account of the user can be paid according to the second payment scheme. That is, when the balance of the account of the user associated with the code payment is less than the amount of money to be paid, the second determination unit 2137 transmits a payment limit allocation request (an authorization request) to the determination device for determining whether or not the second payment scheme is available. The determination device determines whether or not the second payment scheme is valid, whether or not the amount of money to be paid reached a usage limit of the second payment scheme, or the like when the payment limit allocation request is received and transmits approval information representing an approval for the payment limit allocation request (an approval for authorization) to the payment processing device 21 when it is determined that payment limit allocation is possible. The second determination unit 2137 determines whether or not the difference in the amount of money between the amount of money to be paid and the balance of the account of the user can be paid according to the second payment scheme associated with the user by determining whether or not the approval information has been acquired from the determination device.

Also, although the second condition is that the difference in the amount of money between the amount of money to be paid and the balance of the account of the user can be paid according to the second payment scheme, the present invention is not limited thereto. The second condition may be that the user is associated with the second payment scheme.

The payment unit 2138 performs payment of the amount of money to be paid on the basis of the payment request. Specifically, when the balance of the account of the user is greater than or equal to the amount of money to be paid, the payment unit 2138 performs the payment by subtracting the amount of money to be paid represented by the payment information included in the payment request from the balance of the account of the user corresponding to the code payment.

Also, if the second determination unit 2137 determines that the second payment scheme satisfies the second condition when the balance of the account of the user is less than the amount of money to be paid, the payment unit 2138 allows the balance of the account of the user in the code payment to be insufficient and performs payment of the amount of money to be paid according to the code payment.

Specifically, when the second determination unit 2137 acquires the approval information representing the approval for the payment limit allocation request (the approval for authorization) from the determination device, the payment unit 2138 subtracts the amount of money to be paid represented by the payment information included in the payment request from the balance of the account of the user of the user ID stored in the storage unit 212 in association with the payment token included in the payment request acquired by the payment request acquisition unit 2136. Because the balance of the account is less than the amount of money to be paid, the balance of the account after subtraction of the amount of money to be paid is less than 0 yen. Because the payment unit 2138 of the payment processing device 21 subtracts the amount of money to be paid in accordance with the acquisition of the approval for the payment limit allocation request from the determination device, the business operator who operates the code payment can allow the balance of the account of the user to be insufficient on the basis of the allocated payment limit.

Subsequently, the payment unit 2138 executes a process of depositing the amount of money to be paid into the account of the shop identified by the shop ID included in the payment request. Here, the payment unit 2138 may deposit an amount of money obtained by subtracting a payment fee in the payment processing device 21 from the amount of money to be paid into an account of the shop.

When the payment of the amount of money to be paid has been completed, the notification unit 2139 notifies the shop terminal 23 of the payment completion information representing that the payment has been completed. Also, when the payment of the amount of money to be paid has been completed, the notification unit 2139 notifies the user terminal 22 of the payment completion information representing that the payment has been completed.

When the balance of the account of the user corresponding to the code payment is insufficient, the notification unit 2139 notifies the user of payment completion information including information representing that the balance of the account of the user corresponding to the code payment is insufficient after the payment of the amount of money to be paid is performed by the payment unit 2138. For example, the notification unit 2139 notifies the user of the information by transmitting the payment completion information including the information representing that the balance of the account of the user corresponding to the code payment is insufficient to the user terminal 22 which is a transmission source of the payment token.

When the balance of the account of the user associated with the code payment is less than the amount of money to be paid, the notification unit 2139 may notify the user of information for prompting the user to set the second payment scheme as the payment scheme corresponding to the first payment scheme if it is determined that a difference in the amount of money between the amount of money to be paid and the balance of the account of the user can be paid according to the second payment scheme associated with the user. Thereby, the user can perform payment without delay by switching the payment scheme corresponding to the first payment scheme to a payment scheme in which payment is possible.

For example, the notification unit 2139 notifies the user of a difference in the amount of money between the balance before the payment of the amount of money to be paid is performed and the amount of money to be paid, i.e., an insufficient amount of money when the payment of the amount of money to be paid is performed, as information representing that the balance of the account of the user corresponding to the code payment is insufficient. Also, the notification unit 2139 notifies the user of information representing that the balance of the account of the user corresponding to the code payment is insufficient and information for prompting the user to deposit money into the account associated with the code payment. Thereby, the user can recognize the fact that the balance of the account of the user is insufficient and an insufficient amount of money and can deposit money into the account.

Also, the payment unit 2138 requests the cancellation of payment limit allocation in the second payment scheme when an amount of money greater than or equal to the difference in the amount of money between the balance and the amount of money to be paid is deposited into the account of the user associated with the code payment after the allocation of the payment limit corresponding to a difference in the amount of money between the balance before the amount of money to be paid is subtracted and the amount of money to be paid is requested in the second payment scheme. Here, a deposit of the amount of money may be a deposit of an amount of money into which the number of points available as consideration for the payment when the product is purchased is converted.

Also, the payment unit 2138 requests an amount of money corresponding to the payment limit in the second payment scheme when the balance of the account of the user associated with the code payment has been insufficient for a predetermined period after the allocation of the payment limit corresponding to a difference in the amount of money between the balance before the amount of money to be paid is subtracted and the amount of money to be paid is requested in the second payment scheme. In this case, the payment unit 2138 causes an insufficient state of the account balance to be eliminated by requesting the user pay an amount of money corresponding to the payment limit and setting the account balance to 0 yen together with a request for a usage fee of a service used by the user whose payment scheme is the second payment scheme.

Here, the notification unit 2139 may be configured to notify the user that the request for the amount of money corresponding to the payment limit has been transmitted to the user together with the request for the usage fee of the service. Also, the notification unit 2139 may be configured to notify the user that the insufficient state of the account balance has been eliminated in accordance with the request for the amount of money corresponding to the payment limit transmitted to the user.

An account balance, an amount of money to be paid, a payment limit of the second payment scheme, an amount of money to be deposited into an account, and a requested amount of money of the second payment scheme, which are set according to the process of the payment processing device 21, when the balance of the account of the user in code payment is insufficient are the same as those of the example described in the first embodiment.

That is, as shown in FIGS. 5A and 5B, it is assumed that the balance of the account of the user in the code payment before the user purchases a product is 300 yen and the amount of money to be paid when the product is purchased is 700 yen. In this case, the payment unit 2138 allows the balance of the account of the user in the code payment to be insufficient, performs payment of the amount of money to be paid according to the code payment, and requests allocation of a payment limit of an amount of money corresponding to a difference between the balance before the subtraction of the amount of money to be paid and the amount of money to be paid in the second payment scheme. Thereby, the balance of the account becomes −400 yen and 400 yen is allocated as the payment limit.

Subsequently, as shown in FIG. 5A, if 1000 yen is deposited into the account of the user in the code payment within a predetermined period, the balance of the account becomes 600 yen, the insufficient state is eliminated, the payment limit allocation is cancelled, and the amount of money of the allocated payment limit becomes 0 yen.

On the other hand, as shown in FIG. 5B, when there is no deposit in the account of the user in the code payment within the predetermined period, an insufficient amount of money (400 yen) in the account balance is requested in the second payment scheme. Also, the balance of the account is changed to 0 yen in response to the request in the second payment scheme.

### [Flow of Process in Payment Processing Device 21]

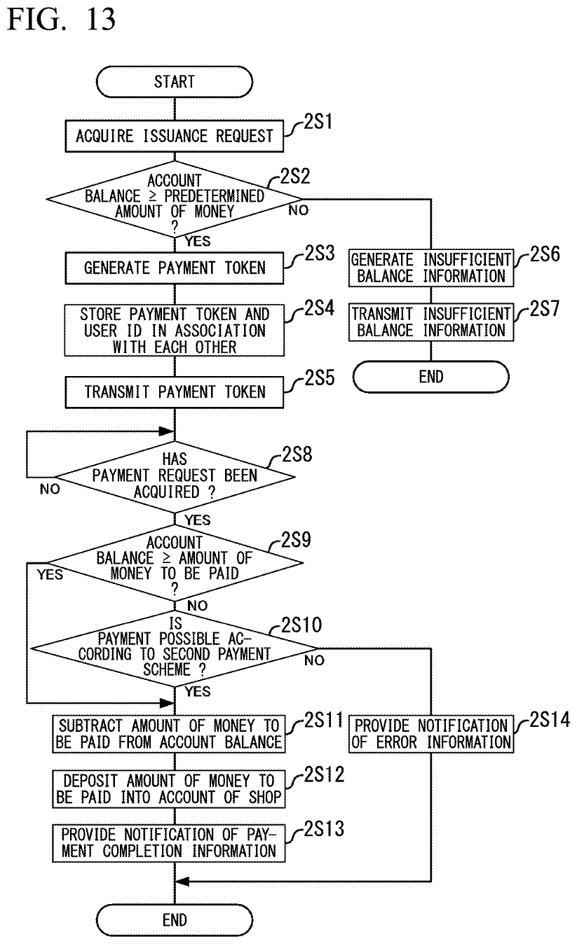

Next, a flow of a process in the payment processing device 21 will be described. First, the flow of the process until the payment processing device 21 performs payment will be described. FIG. 13 is a flowchart showing the flow of the process until the payment processing device 21 performs payment.

First, the issuance request acquisition unit 2132 acquires a payment code issuance request from the user terminal 22 (step 2S1). The issuance request includes a user ID of the user of the user terminal 22.

Subsequently, the first determination unit 2133 determines whether or not a balance of an account associated with code payment of the user corresponding to the user ID included in the issuance request acquired by the issuance request acquisition unit 2132 is greater than or equal to a predetermined amount of money set by the setting unit 2131 (step 2S2). The process moves to step 2S3 if the first determination unit 2133 determines that the balance of the account is greater than or equal to the predetermined amount of money and the process moves to step 2S6 if the first determination unit 2133 determines that the balance of the account is less than the predetermined amount of money.

In step 2S3, the token generation unit 2134 generates a payment token. The token generation unit 2134 causes the storage unit 212 to store the generated payment token and the user ID included in the issuance request in association with each other (step 2S4).

The transmission unit 2135 transmits the payment token to the user terminal 22 that has transmitted the payment code issuance request (step 2S5). Thereby, the payment code is displayed on the user terminal 22.

In step 2S6, the token generation unit 2134 generates insufficient balance information representing that the balance of the account of the user is insufficient.

The transmission unit 2135 transmits the insufficient balance information to the user terminal 22 that has transmitted the payment code issuance request (step 2S7).

After the payment token is transmitted in step 2S5, the payment request acquisition unit 2136 determines whether or not a payment request including payment information, a shop ID, and a payment token has been acquired from the shop terminal 23 (step 2S8). The process moves to step 2S9 if the payment request acquisition unit 2136 determines that the payment request has been acquired and step 2S8 is executed again if the payment request acquisition unit 2136 determines that the payment request has not been acquired.

In step 2S9, the second determination unit 2137 determines whether or not the balance of the account in the code payment of the user of the user ID associated with the payment token included in the payment request is greater than or equal to the amount of money to be paid. The process moves to step 2S11 if the second determination unit 2137 determines that the balance of the account is greater than or equal to the amount of money to be paid and the process moves to step 2S10 if the second determination unit 2137 determines that the balance of the account is less than the amount of money to be paid.

In step 2S10, the second determination unit 2137 determines whether or not the difference in the amount of money between the amount of money to be paid and the balance of the account of the user can be paid according to the second payment scheme associated with the user by requesting the determination device for determining whether or not the second payment scheme is available to allocate the payment limit corresponding to the difference in the amount of money. The process moves to step 2S11 if the second determination unit 2137 determines that the difference in the amount of money can be paid according to the second payment scheme and the process moves to step 2S14 if the second determination unit 2137 determines that the difference in the amount of money cannot be paid according to the second payment scheme.

In step 2S11, the payment unit 2138 performs payment of the amount of money to be paid according to code payment. Here, when it is determined that the balance of the account associated with the code payment is less than the amount of money to be paid in step 2S9, the payment unit 2138 allows the balance of the account of the user in the code payment to be insufficient and subtracts the amount of money to be paid from the balance of the account.

Subsequently, the payment unit 2138 executes a process of depositing the amount of money to be paid into the account of the shop identified by the shop ID included in the payment request (step 2S12).

Subsequently, the notification unit 2139 notifies the user terminal 22 of the payment completion information representing that the payment has been completed (step 2S13). Here, when the balance of the account of the user corresponding to the code payment is insufficient, the notification unit 2139 notifies the user terminal 22 of payment completion information including information representing that the account balance is insufficient.

On the other hand, when it is determined that the difference in the amount of money cannot be paid according to the second payment scheme in step 2S10, the notification unit 2139 notifies the user terminal 22 of error information representing that the amount of money to be paid cannot be paid according to the code payment (step 2S14).

Next, a flow of a process when the balance of the account associated with code payment is insufficient in the payment processing device 21 will be described. FIG. 7 is a flowchart showing the flow of the process when the balance of the account associated with the code payment is insufficient in the payment processing device 21. Also, the present flowchart is executed every predetermined time period (for example, one day).

The payment unit 2138 determines whether or not the insufficient state of the balance of the account has been eliminated when money is deposited into the account of the balance of the insufficient state in a charge process (step 2S21). The process moves to step 2S22 if the payment unit 2138 determines that the insufficient state has been eliminated and the process moves to step 2S23 if the payment unit 2138 determines that the insufficient state has not been eliminated.

In step 2S22, the payment unit 2138 requests the cancellation of the allocation in the second payment scheme with respect to the payment limit allocated in step 2S10 of FIG. 13.

In step 2S23, the payment unit 2138 determines whether or not the balance of the account associated with the code payment has been insufficient for a predetermined period. The process moves to step 2S24 if the payment unit 2138 determines that the balance of the account has been insufficient for the predetermined period and the process related to the present flowchart ends if the payment unit 2138 determines that the account balance has not been insufficient for the predetermined period.

In step 2S24, the payment unit 2138 requests an amount of money corresponding to a payment limit allocated in step 2S10 of FIG. 13 in the second payment scheme.

Subsequently, the payment unit 2138 eliminates the insufficient state of the account balance (step 2S25).

### MODIFIED EXAMPLE 2-1

Although the user terminal 22 displays the payment code, the shop terminal 23 reads the payment code displayed on the user terminal 22, and transmits the payment request to the payment processing device 21 in the above description, the present invention is not limited thereto. For example, the shop terminal 23 may display a payment code and the user terminal 22 may read the payment code and transmit a payment request to the payment processing device 21.

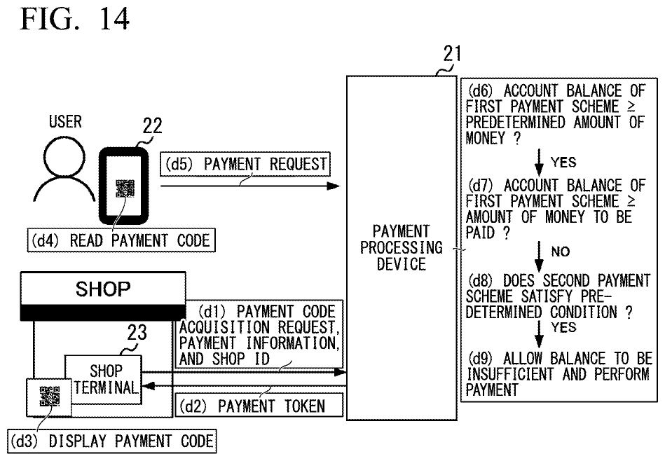

FIG. 14 is a diagram showing a flow of a process when the user terminal 22 transmits a payment request to the payment processing device 21. First, a clerk in a shop reads a barcode attached to a product purchased by the user in the shop terminal 23 and causes the shop terminal 23 to generate payment information representing an amount of money to be paid by the user when the user performs an accounting process in the shop. Also, the clerk performs an operation for causing the shop terminal 23 to display the payment code in the shop terminal 23. The shop terminal 23 transmits a payment code acquisition request, the payment information, and a shop ID to the payment processing device 21 ((d1) in FIG. 14).

When the payment processing device 21 receives the payment code acquisition request, the payment information, and the shop ID from the shop terminal 23, the payment processing device 21 generates a payment token. The payment processing device 21 stores the generated payment token and the shop ID in association with each other in a storage medium. The payment processing device 21 transmits the generated payment token to the shop terminal 23 ((d2) in FIG. 14).

The shop terminal 23 generates a payment code on the basis of the received payment token and causes the payment code to be displayed ((d3) in FIG. 14).

The user terminal 22 reads the payment code displayed on the shop terminal 23 according to, for example, the user's operation ((d4) in FIG. 14). The user terminal 22 transmits a payment request including the user ID and the payment token represented by the read payment code to the payment processing device 21 ((d5) in FIG. 14).

When the payment request is acquired from the user terminal 22, the payment processing device 21 determines whether or not the balance of the account of the user associated with the code payment is greater than or equal to a predetermined amount of money ((d6) in FIG. 14). When the balance of the account of the user is less than the predetermined amount of money, the payment processing device 21 generates insufficient balance information and notifies the user terminal 22 of the insufficient balance information as described above. Here, the payment processing device 21 may notify the user of information for prompting the user to deposit money into the account. Thereby, the payment processing device 21 can perform code payment when the balance of the account is less than the predetermined amount of money and prevent an insufficient amount of money in the balance of the account from increasing.

When it is determined that the balance of the account is greater than or equal to the predetermined amount of money, the payment processing device 21 determines whether or not the balance of the account of the user associated with the code payment is greater than or equal to the amount of money to be paid ((d7) in FIG. 14).

The payment processing device 21 performs payment of the amount of money to be paid when the balance of the account of the user associated with the code payment is greater than or equal to the amount of money to be paid and determines whether or not the second payment scheme associated with the user satisfies the second condition when the balance of the account is less than the amount of money to be paid ((d8) in FIG. 14).

When it is determined that the second payment scheme satisfies the second condition, the payment processing device 21 allows the balance of the account of the user in the code payment to be insufficient and performs payment of the amount of money to be paid according to the code payment ((d9) of FIG. 14).

### MODIFIED EXAMPLE 2-2

Also, although the first payment scheme is code payment in the above description, the present invention is not limited thereto. The first payment scheme may be a prepaid payment scheme in which the balance is managed on the server side such as the payment processing device 21 or a payment scheme in which the amount of money to be paid is withdrawn from a bank account (a debit scheme). In this case, the payment unit 2138 may allow the account balance corresponding to the first payment scheme to be insufficient and perform the payment of the amount of money to be paid according to the first payment scheme.

### MODIFIED EXAMPLE 2-3

Also, although an error message representing the fact that the payment code cannot be displayed without generating the payment token is transmitted to the user terminal 22 when the predetermined amount of money is 0 yen and the payment processing device 21 determines that the balance of the account of the user is less than 0 yen, the payment code is generated in the above description, the present invention is not limited thereto. The predetermined amount of money may be 1 yen or more, for example, 10 yen. Because products capable of being be purchased for less than 10 yen are limited, it is possible to promptly interrupt payment when the balance of the account is likely to be insufficient at the time of payment by preventing the payment token from being generated if the balance of the account of the user is determined to be less than 10 yen.

### [Effect of Payment System]

As described above, when a user ID for identifying a user who has issued a payment code issuance request is acquired from the user terminal 22 in association with code payment, the payment processing device 21 determines whether or not an account associated with code payment of the user corresponding to the user ID satisfies a predetermined condition representing a state in which the payment is possible. When it is determined that the predetermined condition of the account is not satisfied, the payment processing device 21 generates the payment token if it is determined that the predetermined condition is satisfied without causing the user terminal 22 to generate the payment token related to the payment code corresponding to the user. Thereby, the payment processing device 21 can promptly interrupt the payment when the balance of the account is likely to be insufficient at the time of payment.

Although the present invention has been described above using the embodiments, the technical scope of the present invention is not limited to the scope described in the above-described embodiments and various modifications and changes are possible within the scope of the subject matter of the present invention. For example, a specific embodiment of device distribution/integration is not limited to the above embodiment and all or some of devices may be functionally or physically distributed/integrated in any units. Also, a new embodiment produced by any combination of a plurality of embodiments is included in the embodiments of the present invention. The new embodiment produced by the combination also has the effect of the original embodiment.

What is claimed is:

1. A payment processing method comprising:
acquiring, by a computer, a payment request corresponding to a first payment scheme with respect to an amount of money to be paid by a user;
determining, by the computer, whether or not a second payment scheme associated with the user satisfies a predetermined condition when a balance of an account of the user associated with the first payment scheme is less than the amount of money to be paid; and
allowing, by the computer, the balance of the account of the user in the first payment scheme to be insufficient if it is determined that the second payment scheme satisfies the predetermined condition and performing payment of the amount of money to be paid according to the first payment scheme.

2. The payment processing method according to claim 1, wherein the step of performing the payment includes performing the payment without depositing money into the account of the user.

3. The payment processing method according to claim 1, further comprising notifying, by the computer, the user of information representing that the balance is insufficient after the payment of the amount of money to be paid is performed.

4. The payment processing method according to claim 3, wherein the step of notifying includes notifying the user of an amount of money of a difference between the balance before the payment of the amount of money to be paid is performed and the amount of money to be paid after the payment of the amount of money to be paid is performed.

5. The payment processing method according to claim 3, wherein the step of notifying includes notifying the user of information for prompting the user to deposit money into the account of the user associated with the first payment scheme.

6. The payment processing method according to claim 1, further comprising:
determining whether or not the user can perform the payment according to the second payment scheme in the determining step; and
notifying, by the computer, the user of information for prompting the user to switch a payment scheme associated with the first payment scheme to a payment scheme corresponding to the second payment scheme when it is determined that the user can perform the payment according to the second payment scheme in the determining step.

7. The payment processing method according to claim 1, wherein the step of performing the payment includes requesting a determination device for determining whether or not the second payment scheme is available to allocate a payment limit corresponding to an amount of money of a difference between the balance and the amount of money to be paid, allowing the balance of the account of the user in the first payment scheme to be insufficient in accordance with acquisition of approval information representing an approval for the allocation, and performing the payment of the amount of money to be paid according to the first payment scheme in the step of performing the payment.

8. The payment processing method according to claim 7, wherein the step of performing the payment includes requesting cancellation of the allocation of the payment limit in the second payment scheme if an amount of money greater than or equal to the difference in the amount of money between the balance and the amount of money to be paid is deposited into the account of the user associated with the first payment scheme after the allocation of the payment limit corresponding to the difference in the amount of money between the balance and the amount of money to be paid in the second payment scheme is requested.

9. The payment processing method according to claim 1, wherein the step of acquiring the payment request includes acquiring a payment request corresponding to the first payment scheme from a terminal of a shop to which the user pays the amount of money to be paid.

10. A payment processing method comprising:
acquiring, by a computer, user identification information for identifying a user who has transmitted a code issuance request in association with a payment scheme using a code from a terminal of the user;
determining, by the computer, whether or not an account associated with the payment scheme of the user corresponding to the acquired user identification information satisfies a predetermined condition representing a state in which payment is possible; and
generating, by the computer, a token related to the code corresponding to the user displayed on the terminal of the user when it is determined that the account satisfies the predetermined condition.

11. The payment processing method according to claim 10, wherein:
the step of determining includes determining whether or not the balance of the account is greater than or equal to a predetermined amount of money; and
the step of generating includes generating the token when it is determined that the balance of the account is greater than or equal to the predetermined amount of money.

12. The payment processing method according to claim 11, further comprising setting, by the computer, the predetermined amount of money,
wherein the step of determining includes determining whether or not the balance of the account is greater than or equal to the predetermined amount of money set in the setting step.

13. The payment processing method according to claim 12, wherein the step of setting includes acquiring information for setting the predetermined amount of money from the user and setting the predetermined amount of money on the basis of the information.

14. The payment processing method according to claim 12, wherein the step of setting includes acquiring information for setting the predetermined amount of money from a business operator who provides the payment scheme and setting the predetermined amount of money on the basis of the information.

15. The payment processing method according to claim 12, wherein the step of setting includes setting the predetermined amount of money by designating an amount of money that has been determined in advance as an upper limit.

16. The payment processing method according to claim 11, further comprising notifying, by the computer, the user of information about the balance when it is determined that the balance of the account is less than the predetermined amount of money in the determining step.

17. The payment processing method according to claim 16, wherein the step of notifying includes notifying the user of information for prompting the user to deposit money into the account.

18. The payment processing method according to claim 11, wherein the predetermined amount of money is 0 yen.

19. The payment processing method according to claim 11, wherein the predetermined amount of money is an amount of money greater than or equal to 1 yen.

20. The payment processing method according to claim 19, wherein the step of generating the code includes causing the terminal of the user to display the code corresponding to the user when a setting operation is performed so that money is automatically deposited into the account when the balance of the account becomes a set amount of money less than the predetermined amount of money even if it is determined that the balance of the account is less than the predetermined amount of money.
